(19) United States
(12) Patent Application Publication
(10) Pub. No.: US 2015/0268931 A1
(43) Pub. Date: Sep. 24, 2015

(54) Predictive Sorting of Data Elements

(71) Applicant: Avlino, Inc., Holmdel, NJ (US)

(72) Inventors: Gauthaman Vasudevan, Old Bridge, NJ (US); Wei Zhang, Atlantic Highlands, NJ (US)

(21) Appl. No.: 14/664,805

(22) Filed: Mar. 20, 2015

Related U.S. Application Data
(60) Provisional application No. 61/968,189, filed on Mar. 20, 2014.

(51) Int. Cl. G06F 7/36; G06N 99/00; G06F 17/30; G06N 5/02

(52) U.S. Cl. CPC G06F 7/36; G06N 5/025; G06N 99/005; G06F 17/30663

(57) ABSTRACT

In one embodiment, a system that permits large data sets to be sorted using predictive methods. The system has a processor and a memory including one or more storage devices. The processor is adapted to: generate an equation or function characterizing a plurality of data elements; use the equation or function to predict placement of the data elements to create a nearly-sorted list; and perform a final sort of the nearly-sorted list.

### CROSS-REFERENCE TO RELATED APPLICATION

This application claims priority to co-pending U.S. Provisional Patent Application Ser. No. 61/968,189, filed Mar. 20, 2014, the disclosure of which is incorporated herein by reference in its entirety.

### FIELD OF THE INVENTION

The present invention relates generally to data processing and, in particular, to the reordering of data items.

### BACKGROUND

Sorting is the processing of arranging data in an order. This processing is typically accomplished using one or more volatile memory devices (e.g., random-access memory (RAM)) and/or nonvolatile memory devices (e.g., a hard disk drive). Most commonly, data items stored in non-volatile memory are received as input, and volatile memory is used during the sorting process as temporary storage. At the end of the process, the reordered data items are stored back onto the non-volatile memory.

The most common case of sorting is lexicographical ascending or descending order. The processing cost of the sorting is a function of the input data size. A popular conventional sort method such as Quick sort takes O(N log N) time on average, for a random input permutation.

Disadvantageously, for large data sets, conventional sort methods such as Quick can take a relatively long time to execute.

### SUMMARY

Embodiments of the invention provide sorting systems, devices, and methods that permit large data sets to be sorted using predictive methods.

In one embodiment, the invention provides a system for predictively sorting a plurality of data elements. The system has a processor and a memory including one or more storage devices. The processor is adapted to: generate an equation or function characterizing a plurality of data elements; use the equation or function to predict placement of the data elements to create a nearly-sorted list; and perform a final sort of the nearly-sorted list.

In another embodiment, the invention provides an apparatus for predictively sorting a plurality of data elements. The apparatus has a processor and a memory including one or more storage devices. The processor is adapted to: generate an equation or function characterizing a plurality of data elements; use the equation or function to predict placement of the data elements to create a nearly-sorted list; and perform a final sort of the nearly-sorted list.

In a further embodiment, the invention provides a processor-implemented method for predictively sorting a plurality of data elements in a memory including one or more storage devices. The method includes: the processor generating an equation or function characterizing a plurality of data elements; the processor using the equation or function to predict placement of the data elements to create a nearly-sorted list; and the processor performing a final sort of the nearly-sorted list.

### BRIEF DESCRIPTION OF THE DRAWINGS

FIG. 1 is a flowchart showing exemplary steps of a Predefined Function Prediction method, in one embodiment;

FIG. 2 is a flowchart showing exemplary steps of a Weighted Table Prediction method, in one embodiment;

FIG. 3 shows an exemplary multi-dimensional weight array, in one embodiment;

FIG. 4 is a flowchart showing exemplary steps of a Weighted Equation Prediction in one embodiment;

FIG. 5 is a flowchart showing exemplary steps of an Inverse of Simplest Polynomial Function and Bucketing method, in one embodiment;

FIG. 6 is a system diagram showing a predictive sorting system, in one embodiment;

FIG. 7 is a block diagram showing one embodiment of a high-level architecture of Hadoop;

FIG. 8 shows a system, in one embodiment, wherein a predictive sort scheme is integrated into a Hadoop data-processing system to provide enhancements thereto; and

FIG. 9 is a block diagram showing modified high-level architecture of Hadoop, in one embodiment.

### DETAILED DESCRIPTION

The following description sets forth various exemplary embodiments of a scheme for the predictive sorting of data elements in connection with storage of those data elements on one or more memory devices and/or in connection with the transmission of those data elements via one or more communication streams. Embodiments of such a scheme may be implemented in hardware, software, or a combination of hardware and software devices.

In one embodiment, the invention is a method for sorting data. In another embodiment, the invention is an apparatus for sorting data. In another embodiment, the invention is an apparatus that includes a processor configured to perform a method for sorting data. In another embodiment, the invention is a non-transitory machine-readable storage medium having encoded thereon program code, wherein, when the program code is executed by a machine, the machine implements a method for sorting data.

Embodiments of the invention exploit the concept that most of the functionality executed by modern systems is not random, but rather, that most systems have similar input data and are processed by fixed or similar processing functionality. This is true for many systems, in particular, for example, those that run backend office automation processing. Another example would be a system that monitors vehicular traffic flow at a specific time. For example, on Monday mornings, the traffic might peak, and the number of vehicles might be statistically similar on each Monday at the specified time, other than for unexpected reasons, such as a snow storm or a holiday. Every Monday, the number of vehicles observed at that same time of day would be similar. Even further, the types of makes and models would be similar, and even the sets of vehicles observed would be grouped similarly, because, for example, the vehicles entering a given parking lot from a given office would be nearly the same set of vehicles within the specific time window.

Knowing that the input data is similar to what has been seen in the past can be used to process data and functionality extremely quickly and efficiently. There are multiple scenarios in which this concept can be applied, including the sorting of data, the optimization of system memory cache and the optimization of application processing.

Schemes consistent with embodiments of the invention employ behavioral observation techniques to yield improved sorting. Embodiments of the invention employ a predictive sort algorithm, which may have particular utility in the Big Data market (an aggregation of storage, server, networking, software, and services market segments), including, e.g., Apache Hadoop (an open-source software framework for storage and large-scale processing of data-sets on clusters of commodity hardware). Embodiments of the invention employing a predictive sort algorithm may also have particular utility for a wider market of applications outside Big Data, including, e.g., Databases and scientific applications.

Employing a predictive sort algorithm consistent with embodiments of the invention reduces the average cost of sort closer to 2O(N) from the conventional O(N log N) and thus improves performance significantly, especially when N is large. This improvement is realized through prediction of the placement of data being output based on historical characteristics of previously-processed data, leveraging the notion that a specific application's data changes incrementally, and therefore, the patterns exhibited are very similar to the ones observed earlier. A predictive sort algorithm consistent with embodiments of the invention extracts predictive placement information from the prior sorted data. Subsequently, the algorithm refines and adapts the learning in each subsequent iteration to improve prediction of the placement of the data entries.

Although multiple architectures and algorithms can be used to provide predictive placement locations for sorting in embodiments of the invention, four exemplary architectures are discussed below, namely, Predefined Function Prediction, Weighted Table Prediction, Weighted Equation Prediction, and Inverse of Simplest Polynomial Function and Bucketing:

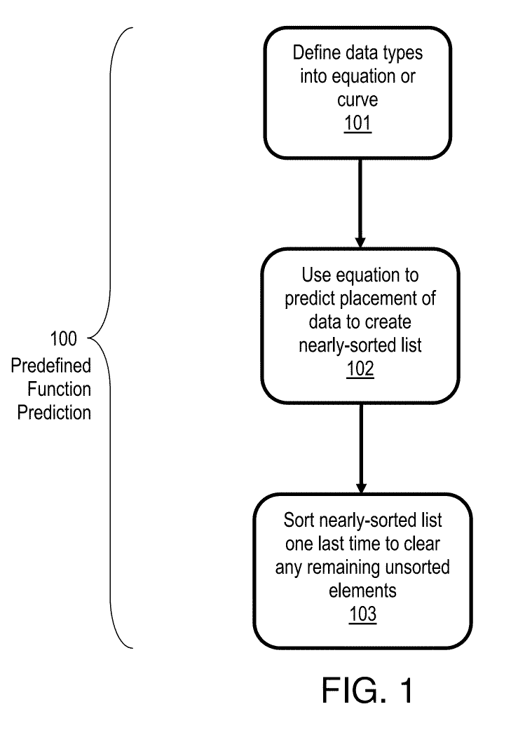

FIG. 1 is a flowchart showing exemplary steps of a Predefined Function Prediction method 100. Predefined Function Prediction architecture is used for cases in which a standard equation or function can describe the input data characteristics. Certain data types, such as normal, binomial, logarithmic and the like, can be defined into an equation or curve, which takes place at step 101. At step 102, this equation is then used to predict the placement of the data to create a nearly-sorted list. At step 103, the nearly-sorted list is then sorted one last time to clear any remaining unsorted elements. An exemplary application for this architecture might be an analysis of heights of people from various regions, or of various races or ages, or the like. When the heights of people are the sort criteria, the equation representing the normal curve can be used to predictively place the data. Even if the midpoint of the normal curve is not known, a reasonably good point can be selected as an initial guess, and the learning algorithm can then iteratively shift and correct until the actual midpoint is obtained.

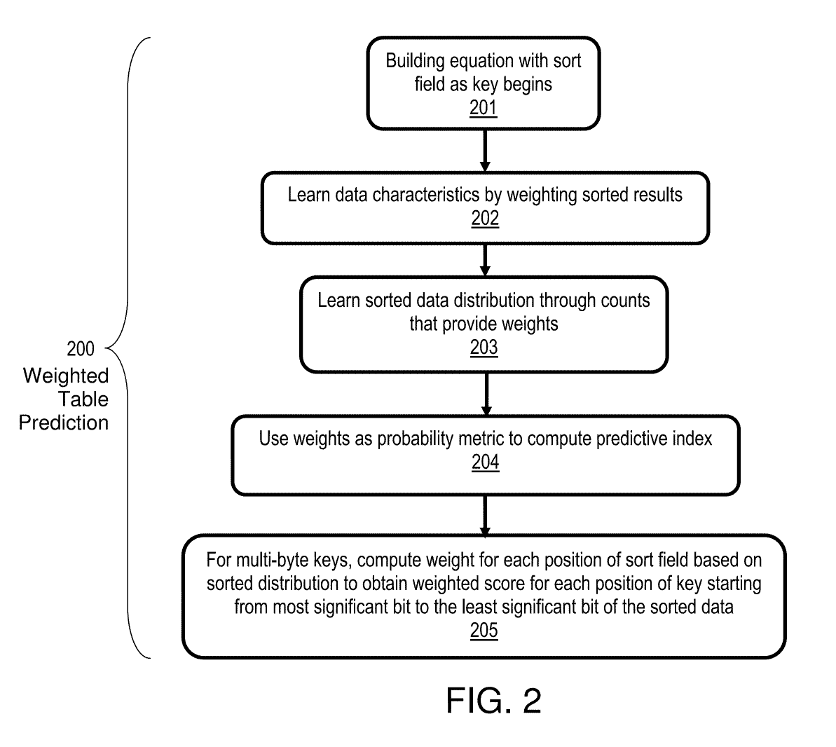

FIG. 2 is a flowchart showing exemplary steps of a Weighted Table Prediction method 200. Weighted Table Prediction architecture is used for cases in which a standard equation or curve cannot be applied, but the equation may subsequently be built, which begins at step 201. The sort field or the item or element used for sorting is referred to as a “key.” At step 202, the data characteristics are learned by weighting the sorted results. At step 203, the sorted data distribution is learned through counts that provide weights. At step 204, the weights are then used as a probability metric to compute a predictive index. At step 205, for multi-byte keys, a weight is computed for each position of the sort field based on the sorted distribution. The result is a weighted score for each position of the key starting from the most significant bit to the least significant bit of the sorted data. It is noted that all of the positions in the key may not impact the sorting process equally. Some key positions might not have any impact at all. Accordingly, in one embodiment, only the relevant positions and their corresponding weights are desirably stored in the form of a multidimensional table or array.

An example of Weighted Table Prediction would be a sort of the set of characters X={c,a,b,a,b,a}, with the sorted result being Y={a,a,a,b,b,c} and the weight array being Weight={a=3, b=2, c=1}. Based on the foregoing sort results, on a subsequent run, if the input data is Z={a,b,a,c,c,b,a,a}, then the result would be predicted as follows: The first ½ entries of the output size (8 positions) would be “a”, followed by ⅓ of “b” and ⅙ of “c”. Based on the above data distribution, “b” would be predicted to be placed at the 5th to 7th position, “a” to be placed in 1st to 4th position, and “c” to be placed at the bottom to the 8^{th} position, with collisions being resolved, e.g., using one of the schemes discussed below.

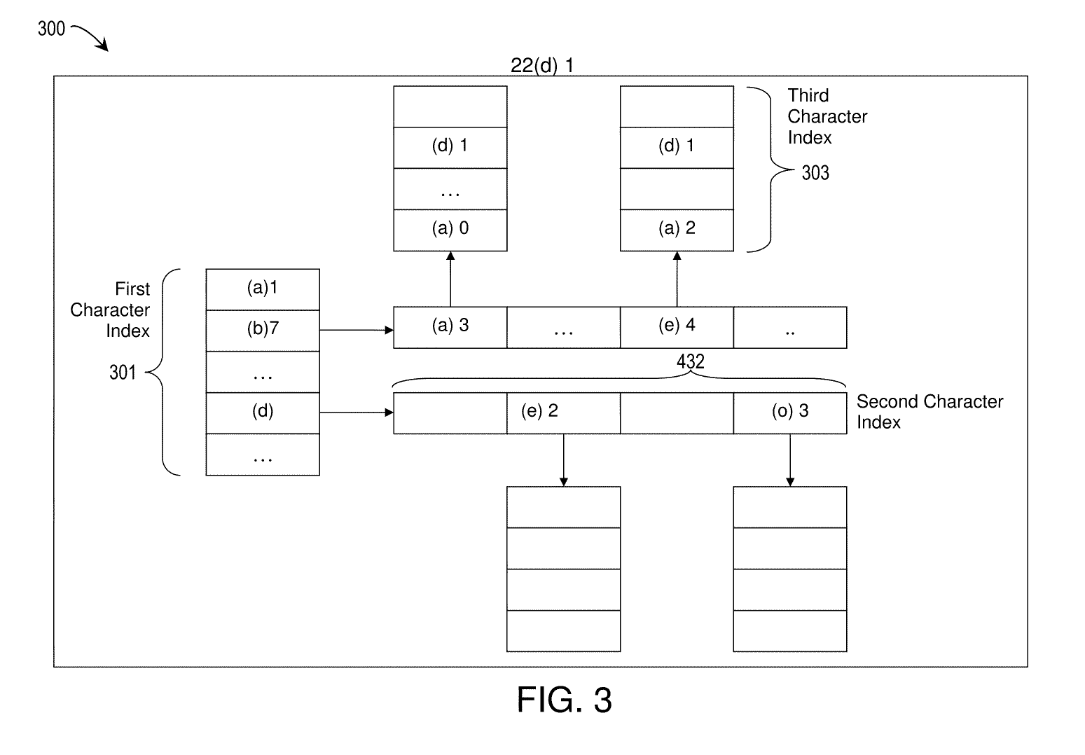

FIG. 3 shows an exemplary multi-dimensional weight array 300, in one embodiment of the invention. The weight distribution is a multi-dimensional vector. The first weight distribution is for the most significant byte, as reflected, e.g., by first character index 301. The sub-distribution is further weighted differently for each subsequent position, as reflected, e.g., by second character index 302 and third character index 303. In this example, words are being sorted, and the input data are X={apple, bat, does, bad, cat, dam, bar, dear, beam, door, bear, deed, bed, doll}, with FIG. 3 showing a portion of possible values of the weighted array.

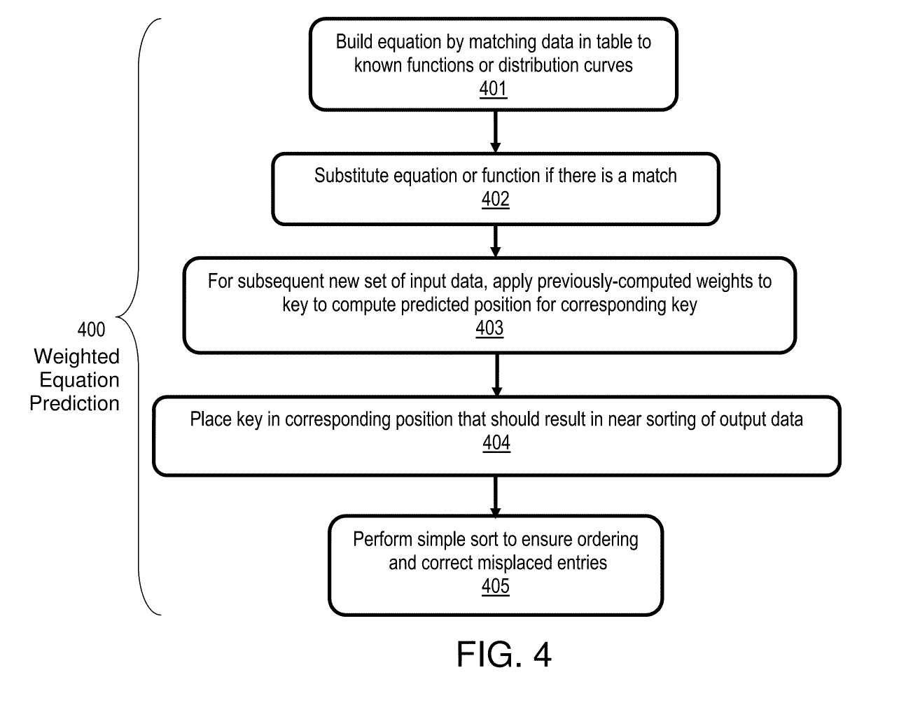

FIG. 4 is a flowchart showing exemplary steps of a Weighted Equation Prediction method 400. Instead of using a table lookup to compute the predictive placement of data elements, Weighted Equation Prediction architecture involves using a weighted array, such as weighted array 300 of FIG. 3, to build a weighted equation or a function, which takes place at step 401. This function or equation is built by matching the data in the table to known functions or distribution curves. At step 402, if there is a match (which may be determined, e.g., using fuzzy logic matching), then the equation or function is substituted. Since many observed distributions will fit into one or more well-known distributions, this architecture can be used with a wide variety of common sorting operations.

There is cost involved in creating the prediction information, such as a weighted table or predefined equation data. For large sets of data, all of the data entries are not needed to compute the weight, but rather, a subset of data set that is sufficiently large can be used to compute a weighted distribution table.

At step 403, for a subsequent new set of input data, the previously-computed weights are applied to the key to compute a predicted position for the corresponding key. At step 404, the key is placed in the corresponding position that should result in the output data being nearly sorted. Subsequent to this, at step 405, a simple sort is performed to ensure ordering and correct any misplaced entries. When the data is nearly sorted, the sorting can be used to complete the sort in close to O(N) time.

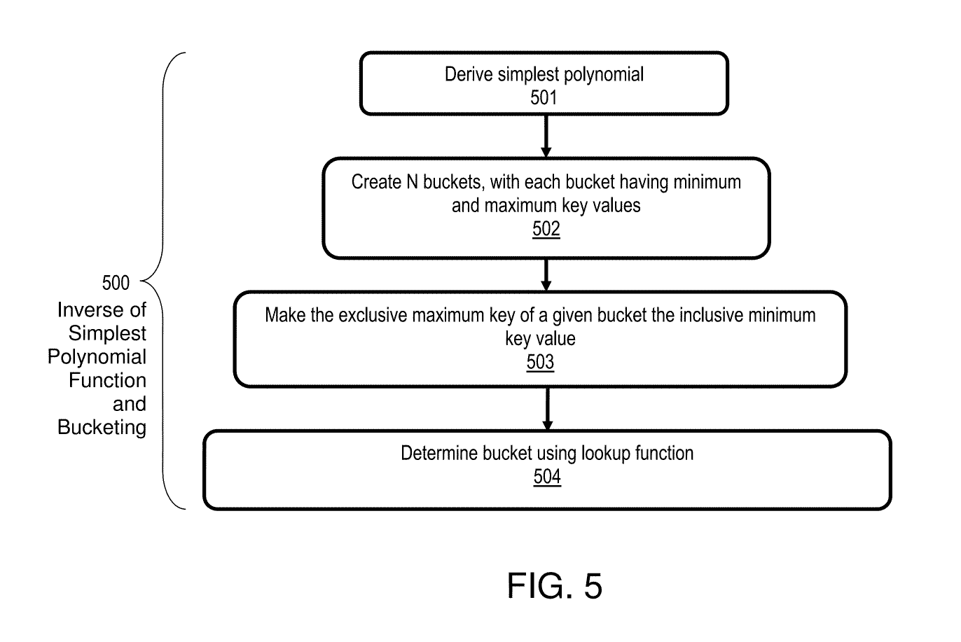

FIG. 5 is a flowchart showing exemplary steps of an Inverse of Simplest Polynomial Function and Bucketing method 500. At step 501, for a given set of numbers, the simplest polynomial, which is used to find the position of a given number in the distribution, is derived.

Bucketing is then performed. In the bucketing operation, at step 502, based on the data distribution, a number N of buckets are created, with each bucket having minimum and maximum key values for the bucket. At step 503, the exclusive maximum key of a given bucket becomes the inclusive minimum key value. At step 504, a lookup function is used to determine the bucket. The lookup function may be, e.g., a search-based function, such as a binary search or a hash-based search.

With any of the above architectures, predictive steps group data in near-linear order but do not ensure that the list will be completely sorted. Accordingly, one final pass is made on the data to sort the data. The optimization for the final pass of the sorting depends on short runs of sorted data and also the grouping of neighboring data items closer together. The sorting algorithm implicitly gains performance not only from O(N) reduction, but also from system gains. The system gains are various system cache efficiencies wherein typically only data within close proximity is reordered.

One issue to consider in a predictive sort operation consistent with embodiments of the invention is how collisions are handled, where a collision (or “overflow” condition) is defined as the occurrence of more than the number of predicted entries attempting to fill the available slots. Collisions can occur due to changes in input patterns or due to the accuracy of prediction. Accuracy can be traded off to accomplish certain latency and throughput performance goals. The handling of collision or overflow conditions is important for the functioning of a predictive sorting operation and may be achieved using a number of different methods. A first exemplary method is to find the nearest available free slot and use it. A second exemplary method is to perform a sort to insert the new data. A third exemplary method is to have a separate overflow buffer that is merged later. A hybrid method is applicable in the case of Hadoop, where both the insertion with a limit and overflow methods are used, which is explained below.

Along with the final pass, the weights for different bit positions are computed and refined. Thus, the algorithm continuously builds a characterization of the data that is being sorted for a specific functionality.

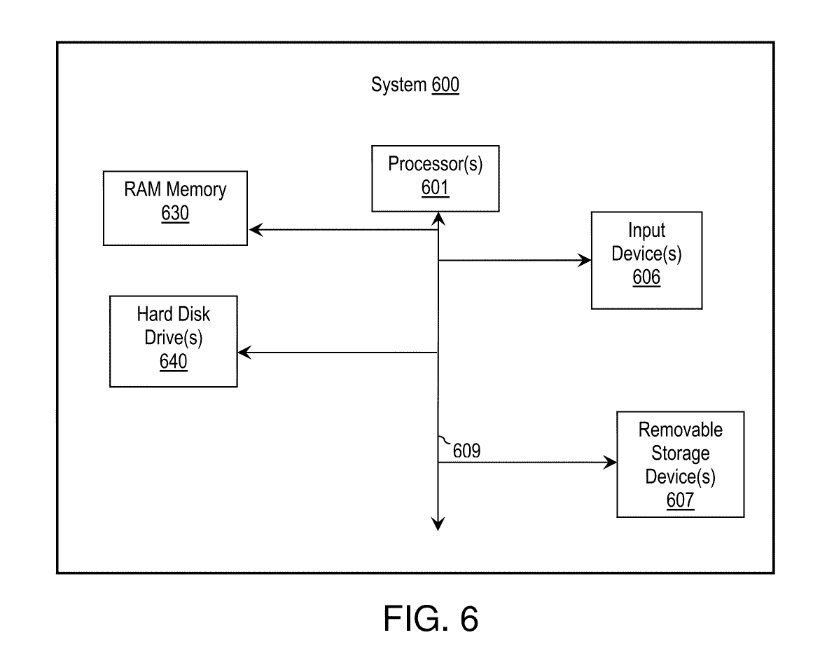

FIG. 6 shows a predictive sorting system 600, consistent with an exemplary embodiment of the invention, that implements one or more of the foregoing-described architectures and/or one or more storage arrays, such as array 300. Other systems, including, e.g., mainframe computers, workstations, personal computers, and smartphones, employing various operating systems, software, and programming languages, may alternatively be used to implement these features, and system600 is merely one example of such a system. A plurality of networked systems sharing data with one another may alternatively implement these features, and these systems can include fault-tolerant and/or parallel-processing subsystems employing different processors.

System 600 processes and sorts data by means of one or more processors 601 (or central processing units (CPUs)). A bus 609 couples processors to, e.g., RAM (i.e., volatile) memory 630, one or more hard disk drives 640, one or more input devices 606 (e.g., keyboard), and one or more removable storage devices 607 (e.g., CD-ROM, flash memory drive, or tape drive).

The data being sorted may reside in a database or other storage structure stored, e.g., in RAM memory 630, on a hard disk drive 640, or on a removable storage device 607, although, typically, nonvolatile storage is used to house large databases.

One specific application of predictive sort schemes consistent with embodiments of the invention is the data-processing model in the Big Data market, e.g., for Big Data technology segments including Hadoop, Storm, Tez, HPCC, and the like. A specific example employing Hadoop will now be described.

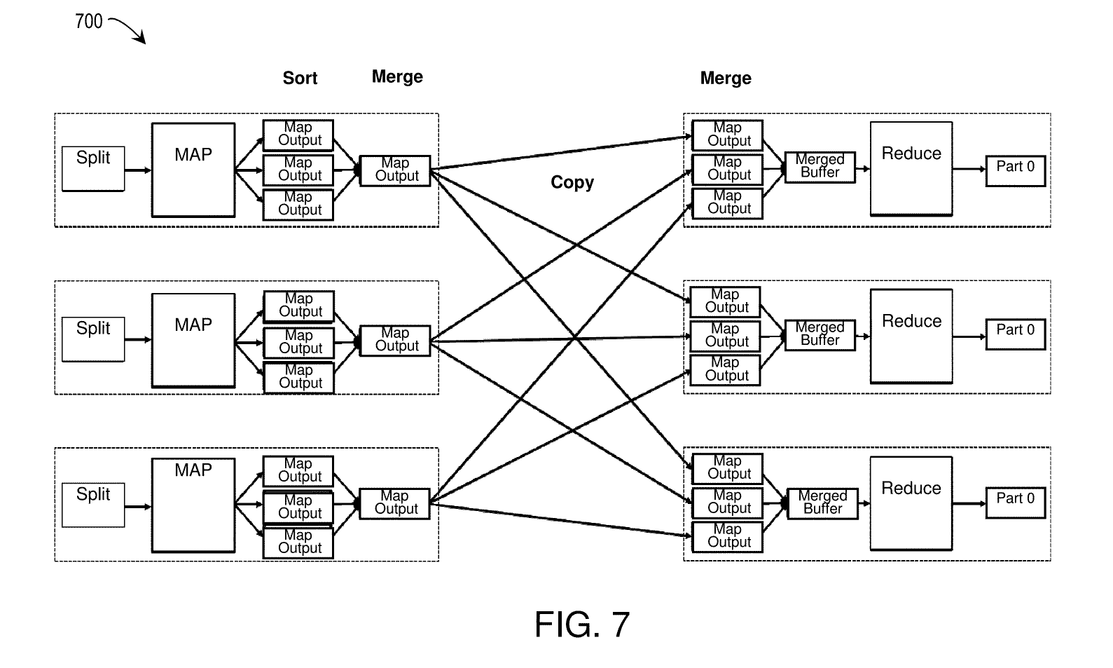

FIG. 7 shows one embodiment of a high-level architecture 700 of Hadoop. Architecturally, Hadoop has two parallelized steps or functions, Map and Reduce. The Map and Reduce functions are the functionality that the customers supply, write, fill in, or otherwise provide. The Hadoop built-in infrastructure sorts and moves data between the Map and Reduce functions. This process of sort-and-transfer is referred to as “shuffle,” “sort and shuffle,” “sort/copy/shuffle,” or the like. As shown in FIG. 7, there are three phases of sorting, two in the Map step and one in the Reduce step. The Map step contains the first sort phase, which is typically a Quick sort. Following that is the optional Merge step, which depends on the volume of data relative to the size of memory. The Reduce step has a Merge step to combine results in a sorted order from the various Map steps.

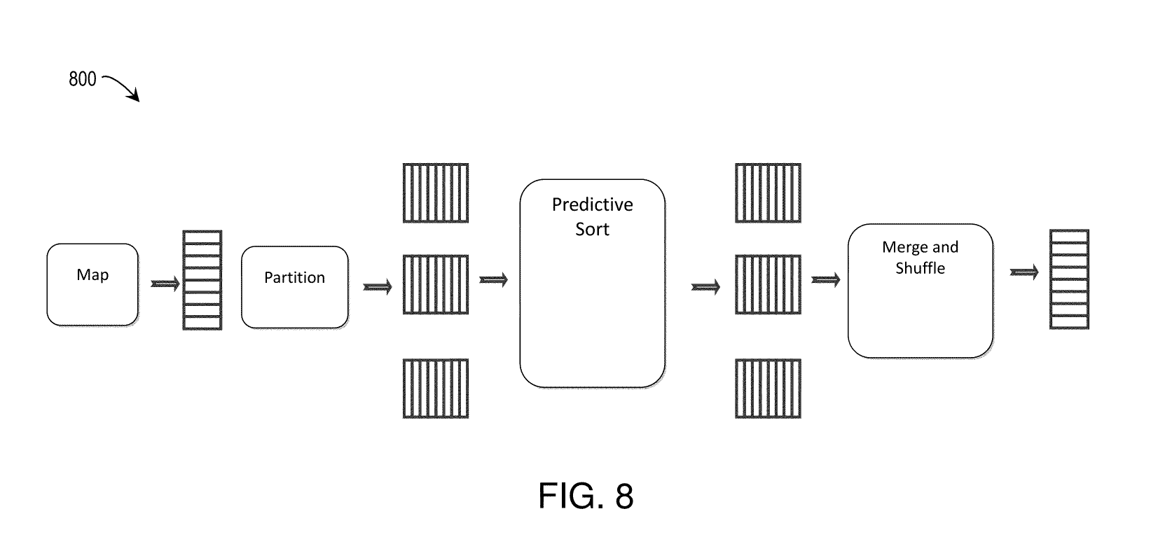

FIG. 8 shows a system 800 consistent with one exemplary embodiment of the invention, wherein a predictive sort scheme is integrated into a Hadoop data-processing system to provide enhancements thereto. In this embodiment, a predictive sort operation is performed between the end of each Map operation and the start of each Reduce operation. This predictive sort algorithm is incorporated along with additional enhancements to Hadoop, to accelerate the entire process of sorting and transferring data from the Map to the Reduce steps.

The predictive sort handles collisions using in-place insertion up to a limit and then an overflow buffer, which is then merged later. This scheme fits well into the existing Hadoop model. The conventional Hadoop framework performs multiple layers of merge using a merge sort operation. Employing an overflow buffer takes advantage of the existing framework, and the data is merged. The number of overflow buffers may vary depending on particular applications, with the typical number of overflow buffers being 2 or 4.

Another option for handling collisions for minimum/maximumranged buckets is to overprovision all of the buckets by a given amount. Subsequent additional overflow flows to the neighboring bucket, and an adjustment is then made in a second pass.

In one embodiment, the predictive sort operation is combined with an optional compression function, which is typically used in the shuffle function that is implemented on both sides of the Map and Reduce functions.

In one embodiment, the predictive sort operation is combined with the network transfer on both the transmit and receive sides.

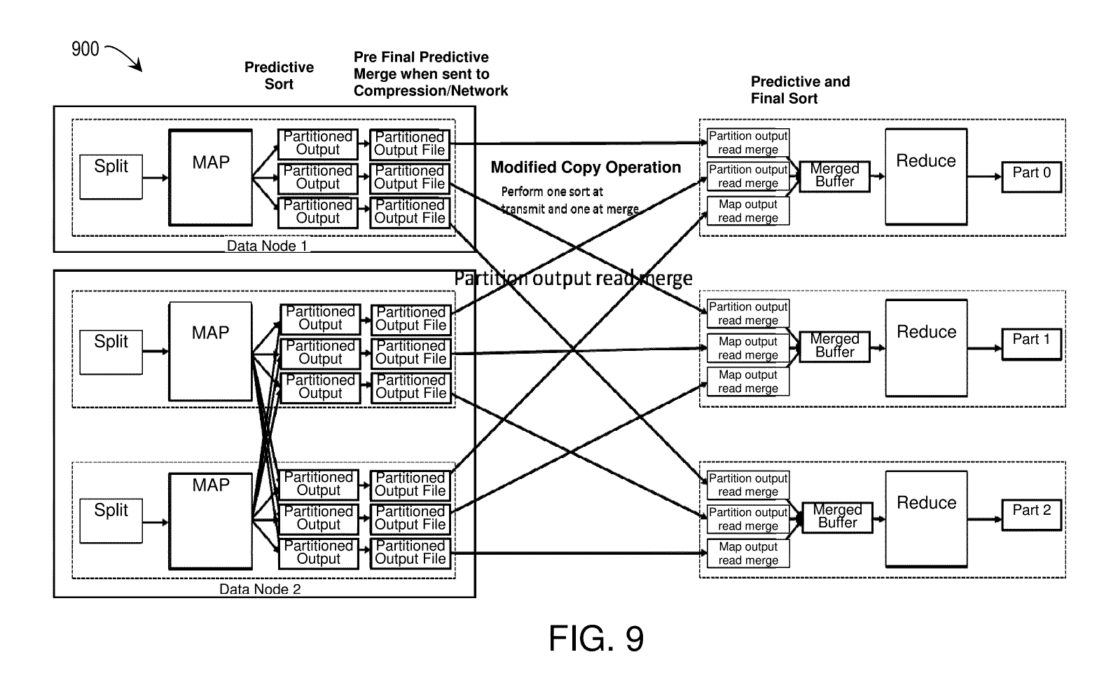

Another additional concept used in predictive sort specifically applicable for Hadoop is illustrated in FIG. 9, which shows a modified high-level architecture 800 of Hadoop, in one embodiment of the invention. In a conventional Hadoop architecture, each Map step outputs data that consists of multiple partitions. The various partitions are then sent to a reducer that merges them all. In the embodiment of FIG. 9, the Map step output is stored per partition across multiple Map steps. First, this approach significantly improves the performance of sorting by reducing the number of merges. Second, having a per-partition store that might span across one or more files can still reduce merge costs significantly. A third benefit is an improvement in the predictive placement of data.

### Alternative Embodiments

Different embodiments of the disclosure may be adaptable for different and specialized purposes. Embodiments of the disclosure may include implementation of a system on a shared server or in a hardened appliance and may be adapted, e.g., to permit data to be sorted across servers on the Internet or in a large heterogeneous environment, such as a private cloud.

It should also be understood that software and/or hardware consistent with embodiments of the disclosure can be employed, e.g., at endpoint nodes of a network, centrally within a network, as part of a network node, between a standalone pair of interconnected devices not networked to other devices, at a user's end, at the server end, or at any other location within a scheme of interconnected devices.

It should be understood that appropriate hardware, software, or a combination of both hardware and software is provided to effect the processing described above, in the various embodiments of the disclosure. It should further be recognized that a particular embodiment might support one or more of the modes of operation described herein.

It should be understood that various changes in the details, materials, and arrangements of the parts which have been described and illustrated in order to explain the nature of embodiments of the disclosure may be made by those skilled in the art without departing from the scope of the disclosure. For example, it should be understood that the inventive concepts of embodiments of the disclosure may be applied not only in systems and devices for sorting data, but also in other applications for which embodiments of the disclosure may have utility, including applications that involve searching within data, filtering data, or the like.

Embodiments of the present disclosure can take the form of methods and apparatuses for practicing those methods. Such embodiments can also take the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing embodiments of the disclosure. Embodiments of the disclosure can also be embodied in the form of program code, for example, stored in a non-transitory machine-readable storage medium including being loaded into and/or executed by a machine, wherein, when the program code is loaded into and executed by a machine, such as a computer, the machine becomes an apparatus for practicing embodiments of the disclosure. When implemented on a general-purpose processor or custom specific processors, the program code segments combine with the processor to provide a unique device that operates analogously to specific logic circuits. The program code may also be implemented in a cloud computing infrastructure or other distributed computing arrangement that involves a large number of computers connected through a communication network such as the Internet, e.g., a software as a service (SaaS) infrastructure, a platform as a service (PaaS) infrastructure, or an infrastructure as a service (IaaS) infrastructure, and may be implemented in a “Big Data” infrastructures, i.e., collections of data sets too large for traditional analytical methods, such as technology segments that employ platforms such as Apache™ Hadoop, Apache™ Storm, Apache™ Tez, the High Performance Computing Cluster (HPCC) Systems Platform, or the like.

It will be appreciated by those skilled in the art that although the functional components of the exemplary embodiments of the system described herein may be embodied as one or more distributed computer program processes, data structures, dictionaries and/or other stored data on one or more conventional general-purpose computers (e.g., IBM-compatible, Apple Macintosh, and/or RISC microprocessor-based computers), mainframes, minicomputers, conventional telecommunications (e.g., modem, T1, fiber-optic line, DSL, satellite and/or ISDN communications), memory storage means (e.g., RAM, ROM) and storage devices (e.g., computer-readable memory, disk array, direct access storage) networked together by conventional network hardware and software (e.g., LAN/WAN network backbone systems and/or Internet), other types of computers and network resources may be used without departing from the present disclosure. One or more networks discussed herein may be a local area network, wide area network, internet, intranet, extranet, proprietary network, virtual private network, a TCP/IP-based network, a wireless network (e.g., IEEE 802.11 or Bluetooth), an e-mail based network of e-mail transmitters and receivers, a modem-based, cellular, or mobile telephonic network, an interactive telephonic network accessible to users by telephone, or a combination of one or more of the foregoing.

Embodiments of the disclosure as described herein may be implemented in one or more computers residing on a network transaction server system, and input/output access to embodiments of the disclosure may include appropriate hardware and software (e.g., personal and/or mainframe computers provisioned with Internet wide area network communications hardware and software (e.g., CQI-based, FTP, Netscape Navigator™, Mozilla Firefox™, Microsoft Internet Explorer™, Google Chrome™, or Apple Safari™ HTML Internet-browser software, and/or direct real-time or near-real-time TCP/IP interfaces accessing real-time TCP/IP sockets) for permitting human users to send and receive data, or to allow unattended execution of various operations of embodiments of the disclosure, in real-time and/or batch-type transactions. Likewise, a system consistent with the present disclosure may include one or more remote Internet-based servers accessible through conventional communications channels (e.g., conventional telecommunications, broadband communications, wireless communications) using conventional browser software (e.g., Netscape Navigator™, Mozilla Firefox™, Microsoft Internet Explorer™, Google Chrome™, or Apple Safari™). Thus, embodiments of the present disclosure may be appropriately adapted to include such communication functionality and Internet browsing ability. Additionally, those skilled in the art will recognize that the various components of the server system of the present disclosure may be remote from one another, and may further include appropriate communications hardware/software and/or LAN/WAN hardware and/or software to accomplish the functionality herein described.

Each of the functional components of embodiments of the present disclosure may be embodied as one or more distributed computer-program processes running on one or more conventional general purpose computers networked together by conventional networking hardware and software. Each of these functional components may be embodied by running distributed computer-program processes (e.g., generated using “full-scale” relational database engines such as IBM DB2™, Microsoft SQL Server™, Sybase SQL Server™, or Oracle 10g™ database managers, and/or a JDBC interface to link to such databases) on networked computer systems (e.g., including mainframe and/or symmetrically or massively-parallel computing systems such as the IBM SB2™ or HP 900™ computer systems) including appropriate mass storage, networking, and other hardware and software for permitting these functional components to achieve the stated function. These computer systems may be geographically distributed and connected together via appropriate wide- and local-area network hardware and software. In one embodiment, data stored in the database or other program data may be made accessible to the user via standard SQL queries for analysis and reporting purposes.

Primary elements of embodiments of the disclosure may be server-based and may reside on hardware supporting an operating system such as Linux, Microsoft Windows NT/2000™ or UNIX.

Components of a system consistent with embodiments of the disclosure may include mobile and non-mobile devices. Mobile devices that may be employed in embodiments of the present disclosure include personal digital assistant (PDA) style computers, e.g., as manufactured by Apple Computer, Inc. of Cupertino, Calif., or Palm, Inc., of Santa Clara, Calif., and other computers running the Android, Symbian, RIM Blackberry, Palm webOS, or iPhone operating systems, Windows CE™ handheld computers, or other handheld computers (possibly including a wireless modem), as well as wireless, cellular, or mobile telephones (including GSM phones, J2ME and WAP-enabled phones, Internet-enabled phones and data-capable smart phones), one- and two-way paging and messaging devices, laptop computers, etc. Other telephonic network technologies that may be used as potential service channels in a system consistent with embodiments of the disclosure include 2.5G cellular network technologies such as GPRS and EDGE, as well as 3G technologies such as CDMA1xRTT and WCDMA2000, and 4G technologies. Although mobile devices may be used in embodiments of the disclosure, non-mobile communications devices are also contemplated by embodiments of the disclosure, including personal computers, Internet appliances, set-top boxes, landline telephones, etc. Clients may also include a PC that supports Apple Macintosh™, Microsoft Windows 95/98/NT/ME/CE/2000/XP/Vista/7/8™, a UNIX Motif workstation platform, Linux, or other computer capable of TCP/IP or other network-based interaction. In one embodiment, no software other than a web browser may be required on the client platform.

Alternatively, the aforesaid functional components may be embodied by a plurality of separate computer processes (e.g., generated via dBase™, Xbase™, MS Access™ or other “flat file” type database management systems or products) running on IBM-type, Intel Pentium™ or RISC microprocessor-based personal computers networked together via conventional networking hardware and software and including such other additional conventional hardware and software as may be necessary to permit these functional components to achieve the stated functionalities. In this alternative configuration, since such personal computers typically may be unable to run full-scale relational database engines of the types presented above, a non-relational flat file “table” (not shown) may be included in at least one of the networked personal computers to represent at least portions of data stored by a system according to embodiments of the present disclosure. These personal computers may run the Unix, Linux, Microsoft Windows NT/2000™ or Windows 95/98/NT/ME/CE/2000/XP/Vista/7/8™ operating systems. The aforesaid functional components of a system according to the disclosure may also include a combination of the above two configurations (e.g., by computer program processes running on a combination of personal computers, RISC systems, mainframes, symmetric or parallel computer systems, and/or other appropriate hardware and software, networked together via appropriate wide- and local-area network hardware and software).

A system according to embodiments of the present disclosure may also be part of a larger system including multi-database or multi-computer systems or “warehouses” wherein other data types, processing systems (e.g., transaction, financial, administrative, statistical, data extracting and auditing, data transmission/reception, and/or accounting support and service systems), and/or storage methodologies may be used in conjunction with those of the present disclosure to achieve additional functionality.

In one embodiment, source code may be written in an object-oriented programming language using relational databases. Such an embodiment may include the use of programming languages such as C++ and toolsets such as Microsoft's .Net™ framework. Other programming languages that may be used in constructing a system according to embodiments of the present disclosure include Java, HTML, Perl, UNIX shell scripting, assembly language, Fortran, Pascal, Visual Basic, and QuickBasic. Those skilled in the art will recognize that embodiments of the present disclosure may be implemented in hardware, software, or a combination of hardware and software.

Accordingly, the terms “server,” “computer,” and “system,” as used herein, should be understood to mean a combination of hardware and software components including at least one machine having a processor with appropriate instructions for controlling the processor. The singular terms “server,” “computer,” and “system” should also be understood to refer to multiple hardware devices acting in concert with one another, e.g., multiple personal computers in a network; one or more personal computers in conjunction with one or more other devices, such as a router, hub, packet-inspection appliance, or firewall; a residential gateway coupled with a set-top box and a television; a network server coupled to a PC; a mobile phone coupled to a wireless hub; and the like. The term “processor” should be construed to include multiple processors operating in concert with one another.

It should also be appreciated from the outset that one or more of the functional components may alternatively be constructed out of custom, dedicated electronic hardware and/or software, without departing from the present disclosure. Thus, embodiments of the disclosure are intended to cover all such alternatives, modifications, and equivalents as may be included within the spirit and broad scope of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present disclosure.

It will be further understood that various changes in the details, materials, and arrangements of the parts which have been described and illustrated in order to explain the nature of this disclosure may be made by those skilled in the art without departing from the spirit and scope of the disclosure.

1. A system for predictively sorting a plurality of data elements, the system comprising:
a processor; and
a memory including one or more storage devices, wherein the processor is adapted to:
generate an equation or function characterizing a plurality of data elements;
use the equation or function to predict placement of the data elements to create a nearly-sorted list; and
perform a final sort of the nearly-sorted list.

2. The system of claim 1, wherein generating the equation or function comprises defining the data elements into a standard equation or curve.

3. The system of claim 1, wherein generating the equation or function comprises building an equation using a sort field as a key.

4. The system of claim 3, wherein building the equation comprises weighting a plurality of sorted data elements to learn one or more characteristics of the data elements.

5. The system of claim 3, wherein building the equation comprises learning the sorted data distribution through counts that provide weights.

6. The system of claim 5, wherein building the equation comprises using the weights as a probability metric to compute a predictive index.

7. The system of claim 3, wherein building the equation comprises, for multi-byte keys, computing a weight for each position of the sort field based on the sorted distribution.

8. The system of claim 1, wherein generating the equation or function comprises storing a weight distribution in a multi-dimensional weight array.

9. The system of claim 8, wherein generating the equation or function comprises using the multi-dimensional weight array to build a weighted equation or function.

10. The system of claim 1, wherein building the weighted equation or function comprises matching data in a table to a known function or curve.

11. The system of claim 10, wherein a known function or curve is substituted if a match is found.

12. The system of claim 11, wherein the processor is further adapted to resolve a collision or overflow condition by finding and using the nearest free slot in an array.

13. The system of claim 11, wherein the processor is further adapted to resolve a collision or overflow condition by performing a sort to insert new data.

14. The system of claim 11, wherein the processor is further adapted to resolve a collision or overflow condition by finding and using the nearest free slot in an array and performing a sort to insert new data.

15. The system of claim 1, wherein the system is used for sorting of data elements of a Hadoop data system.

16. The system of claim 1, wherein the processor is adapted to perform a predictive sort operation between the end of a map operation and the beginning of a reduce operation in the Hadoop data system.

17. The system of claim 1, wherein the Hadoop data system has a plurality of map operations outputting data consisting of multiple partitions that are subsequently merged by a reduce operation, and the output of a plurality of map operations is stored per partition across multiple map operations.

18. The system of claim 1, wherein the processor is adapted to:
for a given set of numbers, derive the simplest polynomial to find the position of a given number in the distribution;
based on the data distribution, create a number N of buckets, with each bucket having minimum and maximum key values;
make the exclusive maximum key of a given bucket become the inclusive minimum key value; and
determine the bucket using a lookup function.

19. Apparatus for predictively sorting a plurality of data elements, the apparatus comprising:
a processor; and
a memory including one or more storage devices, wherein the processor is adapted to:
generate an equation or function characterizing a plurality of data elements;
use the equation or function to predict placement of the data elements to create a nearly-sorted list; and
perform a final sort of the nearly-sorted list.

20. A processor-implemented method for predictively sorting a plurality of data elements in a memory including one or more storage devices, the method comprising:
the processor generating an equation or function characterizing a plurality of data elements;
the processor using the equation or function to predict placement of the data elements to create a nearly-sorted list; and
the processor performing a final sort of the nearly-sorted list.
